(19) United States
(12) Patent Application Publication
(10) Pub. No.: US 2008/0032395 A1
(43) Pub. Date: Feb. 7, 2008

(54) Compost heat exchanger

(76) Inventor: Stephen Goodman, Welland (CA)

Correspondence Address: GOWLING, LAFLEUR HENDERSON LLP, ONE MAIN STREET WEST, HAMILTON, ON, L8P 4Z5, US

(21) Appl. No.: 11/882,576

(22) Filed: Aug. 2, 2007

(30) Foreign Application Priority Data
Aug. 3, 2006 (CA) 2,555,062

(51) Int. Cl. C05F 17/02

(52) U.S. Cl. 435/290.4

(57) ABSTRACT

A device for producing compost and heat from composting, comprises a container for creating, containing, and transferring the compost and the heat. The container comprises a hatch for transferring feedstock into the container and for transferring the compost out of the container, and also comprises conduit bearing a heat-transfer medium, such as water, for transferring the heat out of the compost. The device also comprises wheels for supporting the container in a position to facilitate use of the hatch and for rotating the container.

### FIELD OF INVENTION

The present invention relates to heat exchangers, and especially to water heaters in which heat is created by composting.

### BACKGROUND OF THE INVENTION

As compared to what is disclosed in U.S. Pat. No. 5,144,940, the present invention more readily facilitates mixing what is commonly referred to as a compost pile. As a result, the present invention can more readily create higher temperatures in a compost pile and shorter times to product compost.

### SUMMARY OF THE INVENTION

Disadvantages of prior art heat exchangers, and especially of prior art water heaters in which heat is created by composting, may be overcome according to the present invention.

According to an aspect of the present invention there is provided a device for producing compost and heat from composting, said device comprising:
container means for creating, containing, and transferring said compost and said heat, comprising:
   material-transfer means for transferring feedstock into said container means and for transferring said compost out of said container means;
   heat-transfer means, for transferring said heat out of said compost; and
   support-and-rotation means for supporting said container means in a position to facilitate use of said material-transfer means and for rotating said container means.

### BRIEF DESCRIPTION OF THE DRAWINGS

These and other features of the invention will become more apparent from the following description in which reference is made to the appended drawings wherein:

FIG. 1 shows a partly broken away side view of an embodiment of the device in accordance with an embodiment of the present invention;

FIG. 2 shows a partly broken away end view of an embodiment of the device in accordance with a further embodiment of the present invention; and

FIG. 3 shows a perspective view of components that are inside an embodiment of the device according to the invention.

### DETAILED DESCRIPTION

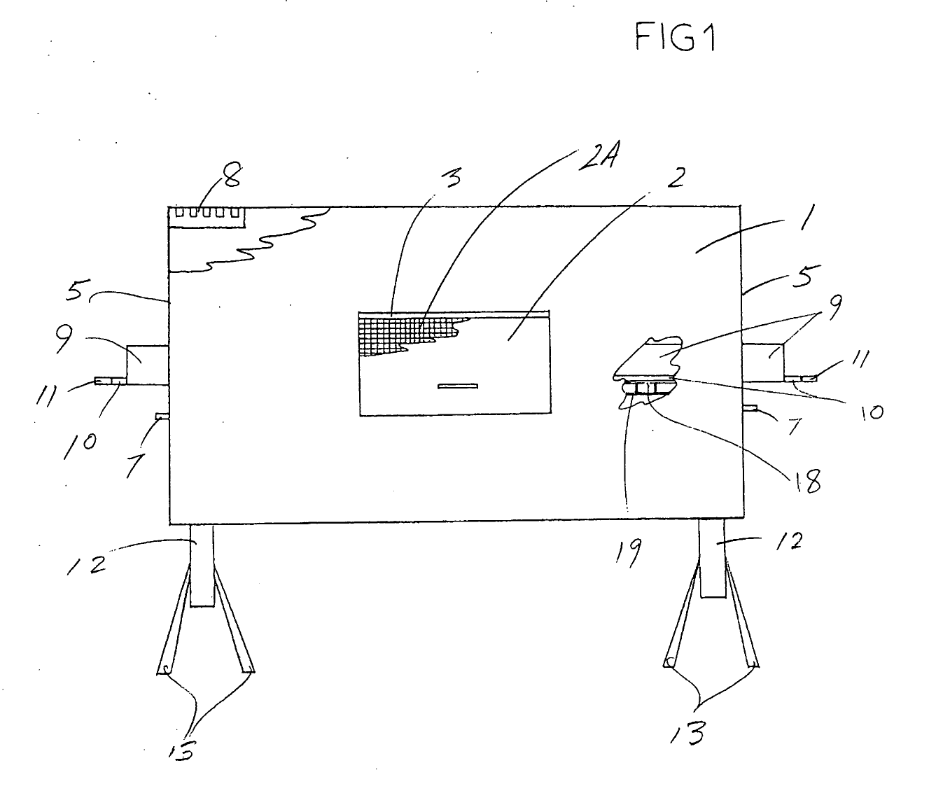

Referring to FIGS. 1 through 3, construction of the preferred embodiment of the device according to the invention will now be described.

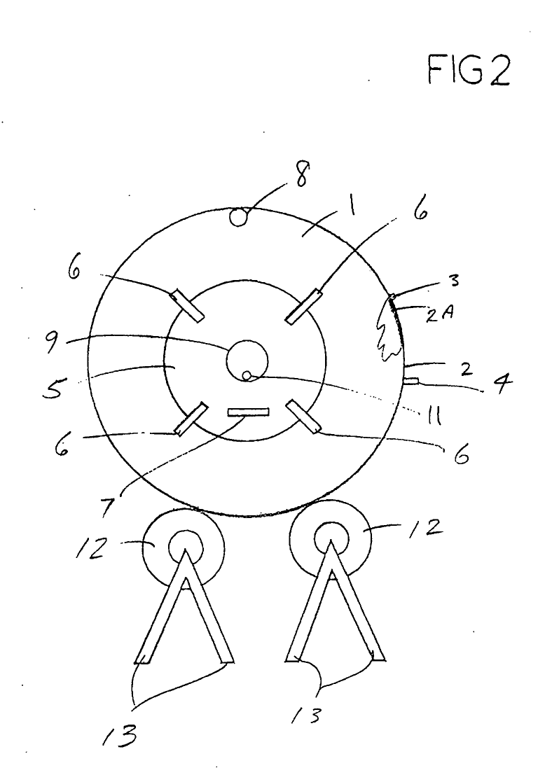

Referring to FIGS. 1 and 2, the container means comprises a right-circular cylindrical, thermally insulated, metal shell 1 approximately 4 feet long and 4 feet in diameter. The material-transfer means comprises an openable and closeable, thermally insulated, metal door 2. The door 2 is conformable with and sealable against the shell 1, and has a hinge 3 and a handle 4; between the door 2 and the interior of the shell 1, there may also be a removable screen 2A having openings large enough to allow more-fully composted material (not shown) to pass through the screen 2A and out of the shell I but small enough to keep less-fully composted material (not shown) in the shell 1, and to thereby facilitate largely continuous production of compost and of heat. (The accompanying drawings do not depict feedstock, compost, water, or partly composted feedstock; except as done in the immediately preceding sentence, for the sake of brevity this specification does not state that such materials are not shown.) The container means further comprises as openable and closeable, thermally insulated, metal door 5 in each end of the shell 1; each door 5 is conformable with and sealable against the shell 1, has latches 6 and handles 7, and is to facilitate servicing components of the device that are inside the shell 1. To provide venting of stale air from the interior of the shell I to the exterior of the shell 1, the shell 1 also comprises a tube 8 through an end of the shell 1 and presenting a comb-like structure to the interior of the shell 1; the tube 8 may also (not shown) be shaped and configured to facilitate pre-heating heat transfer medium, such as water, before the heat-transfer medium enters the shell 1.

The heat transfer means comprises passage means, for pasting heat-transfer medium through the compost, and being a pipe 9 containing a tube 10. The tube 10 comprises rotation-facilitating means, such as mechanical couplings 11, to allow for rotation of components of the device.

The support-and-rotation means comprises two sets each of two air-filled or solid rubber tires 12 on strut and axel assemblies 13. Each set of tires 12 supports and straddles the underside of a respective end of the shell 1.

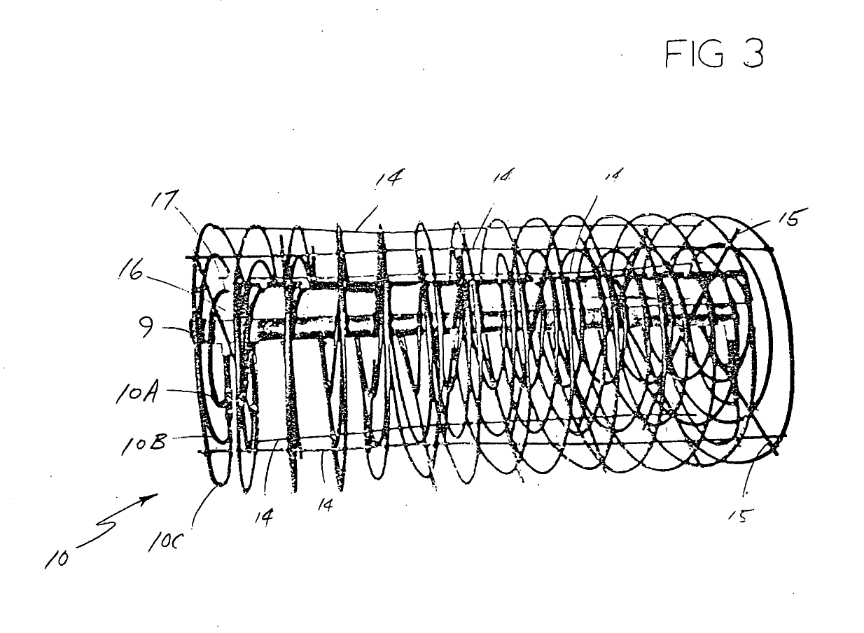

Referring to FIG. 3, the passage means comprising the pipe 9 and the tube 10 is shaped and configured to account for shrinkage and settling of the feedstock, and of the compost, in the shell 1. Being offset downwardly from a horizontal axis of the shell 1, the pipe 9 and the tube 10 can be more within the compost and the feedstock than they would be if either or both of the pipe 9 and the tube 10 was symmetric about such as axis.

The tube 10 is coiled about that axis. That coiling is preferably at more than one diameter, as a plurality of conduits 10A, 10B, and 10C. The conduits 10A, 10B, and 10C commence from an axial portion of the passage means (being the pipe 9), are shaped and configured to pass through the compost and the feedstock, and end in an axial portion of the conduit means (being the pipe 9). Alternatively (not shown), the conduits 10A, 10B, and 10C comprises one continuous conduit that commences from an axial portion of the passage means (being the pipe 9), is shaped and configured to pass through the compost and the feedstock, and ends in an axial portion of the passage means (being the pipe 9). In either event, the shell 1 comprises and opening to at least one of the axial portions, and at least one of the axial portions comprises an opening 18 on its underside, to allow fresh air to get to the feedstock and to the compost, and to allow stale air to exit from the feedstock and the compost; guard means, being a slat 19 offset from that opening 18 on its underside and attached to at least one of those axial portions, is shaped and configured to guard against the compost or the feedstock entering the opening 18 on the underside of the axial portion of the passage means (being the pipe 9). Also in either event, the container 1 comprises positioning-and-supporting means, being struts 14 parallel to but spaced apart from that axis and struts 15 configured radially about that axis, for positioning and supporting the tube 10. The struts 15 comprise a comb-like structure 16 extending from the pipe 9 to engage a coil of the tube 10 in a respective gap 17 in that comb-like structure 16.

The shell 1, the door 2, and the door 5 may, for example, be composed of stainless steel or epoxy-coated metal, or, alternatively, of epoxy-coated wood or fiberglass with carbon fiber on the outside. In any event, the inside surface of each of the shell 1, the door 2, and the door 5, and the surfaces of components of the device that are inside the shell 1, should be chemically inert and be able to withstand the heat, and the dampness, associated with composting.

If the shell 1, but neither the pipe 9 nor the tube 10, are to be rotatable, then especially strong positioning-and-supporting means (such as especially strong struts 14 and especially strong struts 15) are needed to avoid the tube 10 collapsing onto and wrapping around the pipe 9.

Referring to FIGS. 1 through 3, installation and use of a preferred embodiment of the device according to the invention are illustrated.

The types, proportions, and amounts of materials to be inserted into the shell 1 through the door 2 as compost feedstock are well known to those learned in composting. The types of inserted materials can usefully comprise water and a combination of materials such as deciduous leaves, chicken manure, wood clippings, and saw dust. Partly composted feedstock which has been removed through the door 2 along with compost, can be returned through the door 2 as feedstock. Also, the volume of the compost pile in the preferred embodiment of the invention is approximately 1 cubic yard.

Three sets of test results with that volume of compost pile in a preferred embodiment of the invention are set out below, solely by way of example. In all three tests, the compost pile temperature was approximately 150 degrees Fahrenheit.

In one test of a device according to the preferred embodiment of the invention, water at approximately 45 degrees Fahrenheit input to the upstream end of the device exited approximately one minute later from the downstream end of the device at approximately 120 degrees Fahrenheit.

In two other tests of a device according to the preferred embodiment of the invention, water with a flow rate of approximately 1.3 gallons per minute input to the upstream end of the device at approximately 60 degrees Fahrenheit exited at the downstream end of the device; the temperature of the water exiting was, in one test, 110 degrees Fahrenheit and, in another test, 130 degrees Fahrenheit.

As a result of the foregoing, the device of the present invention may be used to produce heated water to be used for baths or shows or for forced air heating of spaces such as the interiors of buildings.

It will be apparent to persons skilled in the art that a number of variations and modifications can be made without departing from the scope of the invention as defined in the claims.

What is claimed is:

1. A device for producing compost and heat from composting, said device comprising:
container means for creating, containing, and transferring said compost and said heat, comprising
material-transfer means for transferring feedstock into said container means and for transferring said compost out of said container means and
heat-transfer means, for transferring said heat out of said compost; and
support-and-rotation means for supporting said container means in a position to facilitate use of said material-transfer means and for rotating said container means.

2. A device as claimed in claim 1, wherein said heat-transfer means comprises passage means for passing heat-transfer medium through said compost.

3. A device as claimed in claim 2, wherein said passage means is shaped and configured to account for shrinkage and settling of said feedstock and of said compost in said container means.

4. A device as claimed in claim 3, wherein said passage means are to be more within said compost and said feedstock than said passage means would be if said passage means was symmetric about a horizontal axis of said container means.

5. A device as claimed in claim 4, wherein said passage means is offset downwardly from said axis.

6. A device as claimed in claim 5, wherein said passage means comprises conduit means coiled about said axis.

7. A device as claimed in claim 2, wherein said passage means comprises conduit means coiled at more than one diameter.

8. A device as claimed in claim 7, wherein said conduit means comprises one continuous conduit that commences from an axial portion of said passage means, is shaped and configured to pass through said compost and said feedstock, and ends in an axial portion of said passage means.

9. A device as claimed in claim 7, wherein said conduit means comprises a plurality of conduits that commence from an axial portion of said passage means, are shaped and configured to pass through said compost and said feedstock, and end in an axial portion of said passage means.

10. A device as defined in claim 8, wherein
said container means comprises an opening to at least one of said axial portions; and
at least one of said axial portions comprises an opening on its underside, to allow fresh air to get to said feedstock and said compost and to allow stale air to exit from said feedstock and said compost.

11. A device as claimed in claim 2, wherein said passage means comprises rotation-facilitating means to allow rotation of said container means about said axis.

12. A device as claimed in claim 11, wherein said rotation-facilitating means comprises a mechanical coupling to allow said rotation.

13. A device as claimed in claim 1, wherein said container means comprises positioning-and-supporting means for positioning and supporting said conduit means.

14. A device as claimed in claim 13, wherein said positioning-and-supporting means comprise struts parallel to but spaced apart from said axis.

15. A device as claimed in claim 13, wherein said positioning-and-supporting means comprise struts configured radially about a horizontal axis of said container means.

16. A device as claimed in claim 15, wherein said struts configured radially comprise a comb-like structure extending from an axial portion of said passage means to engage a coil of said conduit means in a respective gap in said comb-like structure.

17. A device as claimed in claim 1, wherein said support means comprise two sets of wheels on which said container means rests such that each set supports and straddles the underside of a respective end of said container means.

18. A device as claimed in claim 1, comprising vent means to provide venting of stale air from the interior of said container means to the exterior of said container means.

19. A device as claimed in claim 18, wherein said vent means comprises a tube through an end of said container means and presenting a comb-like structure to said interior.

20. A device as claimed in claim 2, comprising vent means shaped and configured to facilitate pre-heating of said heat-transfer medium.

21. A device as claimed in claim 10, further comprising guard means shaped and configured to guard against said compost or said feedstock entering said opening on its underside.

22. A device as claimed in claim 21, wherein said guard means comprises a slat offset from said opening on its underside and attached to at least one of said axial portions.
